(19) United States
(12) Patent Application Publication
(10) Pub. No.: US 2007/0081675 A1
(43) Pub. Date: Apr. 12, 2007

(54) Method and apparatus for outputting an audio signal according to a DMB channel

(75) Inventor: Ki-Hyun Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/478,187

(22) Filed: Jun. 29, 2006

(30) Foreign Application Priority Data
Jun. 29, 2005 (KR) 2005-56998

(51) Int. Cl. H04H 5/00

(52) U.S. Cl. 381/10; 381/2

(57) ABSTRACT

A method and apparatus for outputting an audio signal according to a DMB channel are provided. The default volume level of a DMB signal received on each DMB channel is compared with a plurality of predetermined volume levels available to the DMB terminal. Correction values are determined according to the differences between the default volume level and the predetermined volume levels and stored for the each DMB channel. Upon receiving a DMB signal, a correction value is read according to a DMB channel on which the DMB signal is received and a current volume level set for the DMB terminal. Thereafter, the default volume level of the DMB signal is corrected, i.e., amplified or attenuated, using the correction value. Accordingly, the DMB terminal outputs an audio signal at a constant volume level when a predetermined volume level is fixedly set for the DMB terminal.

### PRIORITY

This application claims priority under 35 U.S.C. § 119 to an application entitled “Method and Apparatus for Outputting Audio Signal According to DMB Channel” filed in the Korean Intellectual Property Office on Jun. 29, 2005 and assigned Serial No. 2005-56998, the contents of which are incorporated herein by reference.

### BACKGROUND OF THE INVENTION

1. Field of the Invention

The present invention relates generally to a Digital Multimedia Broadcasting (DMB) terminal, and in particular, to a method and apparatus for outputting an audio signal according to a DMB channel in a DMB terminal.

2. Description of the Related Art

Typically, a DMB system transmits broadcasting content provided by a plurality of broadcasting content providers to subscribers on different DMB channels set for the broadcasting content providers. Because different broadcasting content providers provide content on different DMB channels, the default volume levels of audio signals included in broadcasting content is also different. That is, the default volume level of an audio signal in a DMB signal is different on each DMB channel.

Unless otherwise set by a user, a conventional DMB terminal adds a fixed volume level set for the terminal to the default volume level of an audio signal in a received DMB signal. For example, if the set volume level is level 3, the conventional DMB terminal outputs a DMB audio signal with the sum of level 3 and the default volume level of an audio signal included in a received DMB signal.

Due to the difference in the default volume level of a DMB audio signal on each DMB channel, if the user changes the DMB channel, the volume level of a final DMB audio signal is also changed.

Therefore, the output audio volume increases or decreases as the DMB channel is changed during DMB viewing and as a result, the user inconveniently needs to adjust the volume level of the DMB terminal each time the DMB channel is changed.

### SUMMARY OF THE INVENTION

Accordingly, the present invention has been designed to substantially solve at least the above problems and/or disadvantages and to provide at least the advantages below.

An object of the present invention is to provide a method and apparatus for outputting a DMB audio signal at a same volume level even though a DMB channel is changed in a DMB terminal.

Another object of the present invention is to provide a method and apparatus for outputting an audio signal according to a DMB channel in the manner that facilitates user manipulation in a DMB terminal.

The above objects are achieved by providing a method and apparatus for outputting an audio signal according to a DMB channel.

According to one aspect of the present invention, in a method of outputting an audio signal according to a DMB channel in a DMB terminal, the default volume level of a DMB signal received on each DMB channel is compared with a plurality of predetermined volume levels available to the DMB terminal. Correction values are determined according to the differences between the default volume level and the predetermined volume levels and stored for the each DMB channel. Upon receiving a DMB signal, a correction value is read according to a DMB channel on which the DMB signal is received and a current volume level set for the DMB terminal. The default volume level of the DMB signal is amplified or attenuated using the correction value. Therefore, the DMB terminal outputs an audio signal at a constant volume level when a predetermined volume level is fixedly set for the DMB terminal.

According to another aspect of the present invention, in an apparatus for outputting an audio signal according to a DMB channel in a DMB terminal, a memory stores a plurality of volume levels available to the DMB terminal. A DMB processor compares the default volume level of a DMB signal received on each DMB channel with the plurality of volume levels, determines correction values according to the differences between the default volume level and the predetermined volume levels, stores the correction values for the each DMB channel, reads a correction value according to a DMB channel on which a DMB signal is received and a current volume level set for the DMB terminal, and corrects, i.e., amplifies or attenuates, the default volume level of the DMB signal using the correction value.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram illustrating a DMB terminal to which the present invention is applied;

FIG. 2 is a flowchart illustrating an operation of the DMB terminal according to an embodiment of the present invention; and

FIG. 3 is a table listing correction values according to an embodiment of the present invention.

### DETAILED DESCRIPTION OF THE PREFERRED EMBODIMENT

Preferred embodiments of the present invention will be described herein below with reference to the accompanying drawings. In the following description, well-known functions or constructions are not described in detail because they would obscure the invention in unnecessary detail.

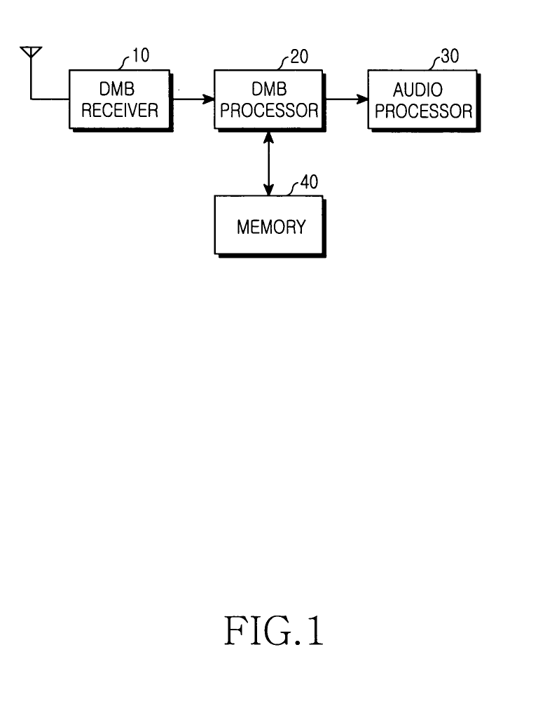

FIG. 1 is a block diagram illustrating a DMB terminal to which the present invention is applied. Referring to FIG. 1, the DMB terminal includes a DMB receiver 10, a DMB processor 20, an audio processor 30, and a memory 40. The DMB receiver 10 receives a DMB signal under the control of the DMB processor 20 and provides the DMB signal to the DMB processor 20. The DMB processor 20 decodes the DMB signal according to key data received from a keypad (not shown), provides video data in the decoded DMB signal to a display (not shown), and provides audio data in the decoded DMB signal to the audio processor 30. The audio processor 30 is connected to an audio output device and outputs the audio data to the audio output device.

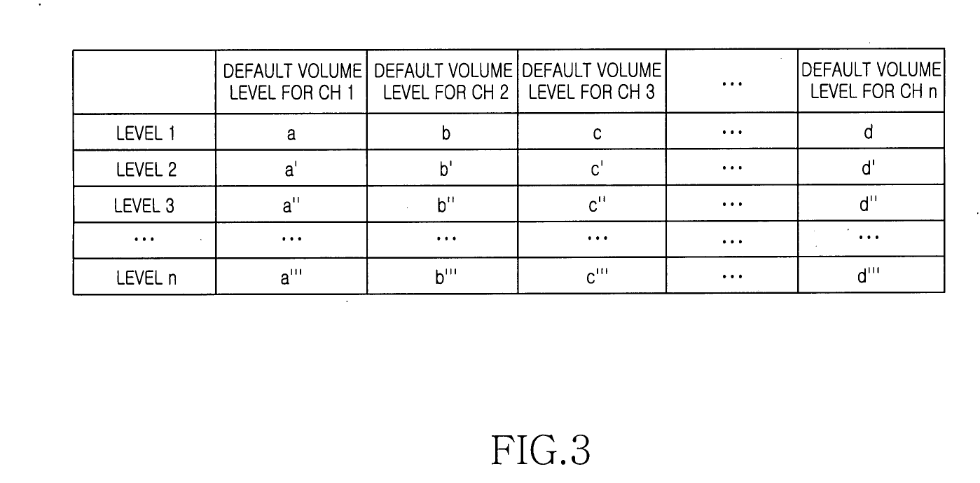

The memory 40 stores programs for processing and control in the DMB processor 20, reference data, and updatable data to be stored. The memory 40 also provides a working memory for the DMB processor 20. According to an embodiment of the present invention, the memory 40 stores a correction value table listing correction values with respect to the volume levels of received DMB audio signals. An example of the correction value table is illustrated in FIG. 3.

FIG. 3 illustrates a correction value table according to the embodiment of the present invention. Referring to FIG. 3, the correction values can be determines according to the default volume levels of DMB signals and the volume level of the DMB terminal. The default volume levels are set for the DMB signals by DMB servers. Further, the default levels may be different depending on DMB channels or DMB contents providers. A plurality of volume levels are pre-stored in the memory 40 for the DMB terminal. One of the volume levels is set in the DMB terminal by a user. This volume level set in the DMB terminal determines the final volume level of an output audio signal. That is, the default volume level of a received DMB audio signal is amplified or attenuated according to the set volume level.

Accordingly, to solve a problem of the conventional procedure in which the final output volume level being changed due to different default volume levels of DMB signals delivered on different DMB channels, in the present invention, a correction value table is used in order to output a DMB audio signal at a same volume level in the DMB terminal, where a fixed volume level has been set.

In order to create the correction value table, the DMB receiver 20, if a current set DMB channel is initially received, detects the default volume level of a received DMB signal, compares a plurality of pre-stored volume levels, and stores the differences as correction values for the DMB channel in the correction value table. A correction value is negative (−) if a volume level exceeds a default volume level and it is positive (+) if the volume level is less than the default volume level.

The DMB processor 20 then reads a correction value from the correction value table according to a volume level set in the DMB terminal and amplifies or attenuates the default volume level of a received DMB signal on a DMB channel. If the correction value is negative, the default volume level is attenuated, whereas if the correction value is positive, the default volume level is amplified.

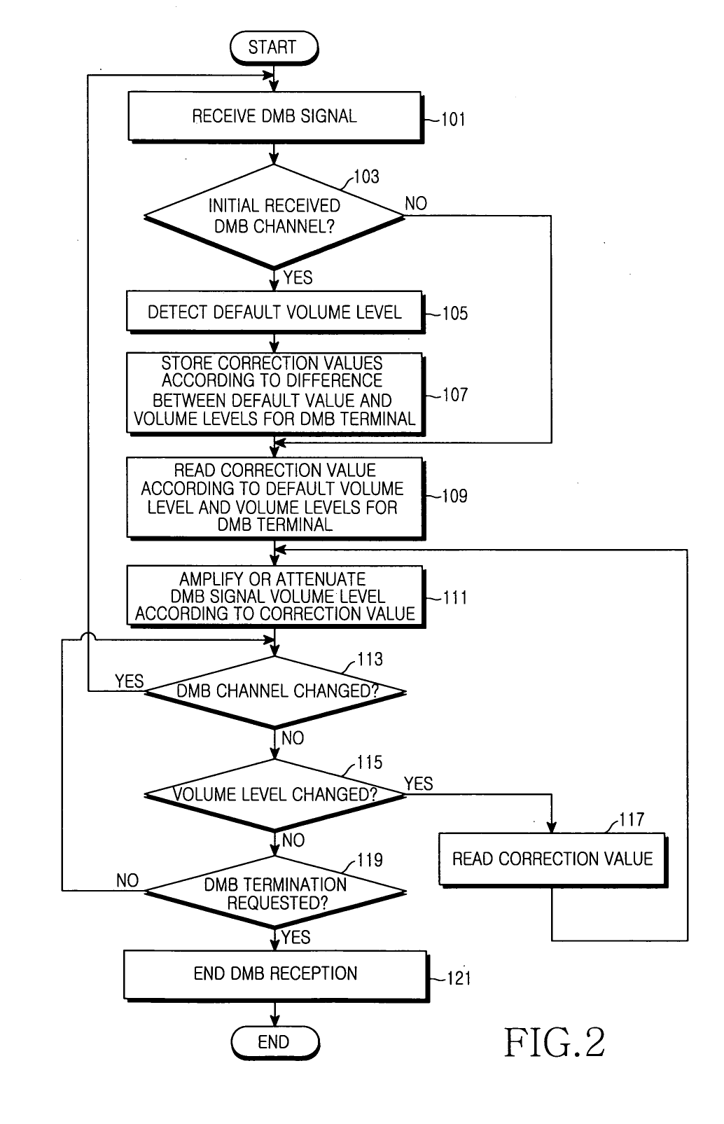

FIG. 2 is a flowchart illustrating an operation of the DMB terminal according to an embodiment of the present invention. Referring to FIG. 2, upon receiving a DMB signal on a current set DMB channel in step 101, the DMB processor 20 determines if the DMB signal has been received initially on the DMB channel in step 103. If the DMB signal has been received initially on the DMB channel, the step 105 is performed, and otherwise, the step 109 is performed. The DMB processor 20 detects the default volume level of the DMB signal in step 105 and stores correction values determined according to the difference between the default volume level and a plurality of volume levels available for the DMB terminal in a correction value table in step 107.

In step 109, the DMB processor 20 reads a correction value from the correction value table according to the default volume level and a current volume level set for the DMB terminal. The DMB processor 20 amplifies or attenuates the default volume level of the received DMB signal according to the correction value and outputs a final DMB audio signal in step 111.

To summarize the above operation, the DMB processor 20 determines if the current DMB channel has been initially received, i.e., if it is this the first time the current DMB channel is being received, in step 103. If this is the first time the current DMB channel is being received, the DMB processor 20 updates the correction table with respect to the current DMB terminal in steps 105 and 107. However, if the current DMB terminal has been received before, the DMB processor 20 reads a corresponding correction value in step 109 and compensates the volume level of the DMB signal in step 111.

When the DMB channel is changed in step 113, the process returns to step 101. If the DMB channel is not changed, the DMB processor 20 determines if the user has requested changing of the volume level for the DMB terminal in step 115. Upon request of the volume level change, the process proceeds to step 117. However, if there is no volume level change request, the process proceeds to step 119.

In step 117, the DMB processor 20 reads a corresponding correction value according to the changed volume level and the default volume level of a received DMB audio signal, and then returns to step 111. That is, if the DMB channel is changed or the volume level is changed by a user, the DMB processor 20 reads a corresponding correction value and adjusts the final audio volume level of the DMB audio signal, in order to maintain the same volume level.

When a DMB termination request has been received in step 119, the DMB processor 20 ends the DMB reception in step 121. If there is no DMB termination request, the process returns to step 113.

as described above, in the present invention, the audio output of a received DMB audio signal is maintained at a constant level in the DMB terminal.

More specifically, in accordance with the present invention as described above, the default volume level of a received DMB signal is compared with a plurality of volume levels that can be set in a DMB terminal. The correction values are determined according to the differences between each other and are stored in a correction value table. Thereafter, upon receiving a DMB signal, a correction value is read from the correction value table according to the default volume level of the DMB signal and a current set volume level for the DMB terminal, and the DMB signal is corrected, i.e., amplified or attenuated, using the correction value. Therefore, the DMB terminal outputs an audio signal at a constant volume level when a volume level has been fixedly set for the DMB terminal.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method of outputting an audio signal according to a digital multimedia broadcasting (DMB) channel in a DMB terminal, the method comprising the steps of:
comparing a default volume level of a DMB signal received on each of a plurality of DMB channels with a plurality of predetermined volume levels available to the DMB terminal;
determining correction values according to differences between the default volume level and the plurality of predetermined volume levels;
storing the correction values for each of the plurality of DMB channels;
receiving of a DMB signal;
reading a correction value according to a DMB channel on which the DMB signal is received and a current volume level set for the DMB terminal; and
correcting the default volume level of the DMB signal using the correction value.

2. The method of claim 1, wherein the step of determining the correction values comprises the steps of:
setting a correction value for attenuating a default volume level, if the default volume level is less than a preset volume level; and
setting a correction value for amplifying the default volume level, if the default volume level is greater than the preset volume level.

3. A method of outputting an audio signal according to a digital multimedia broadcasting (DMB) channel in a DMB terminal, comprising the steps of:
determining if a current DMB channel is being received for a first time;
if the current DMB channel is being received for the first time, comparing the default volume level of a DMB signal received on the current DMB channel with a plurality of predetermined volume levels available to the DMB terminal, determining correction values according to differences between the default volume level and the plurality of predetermined volume levels, and storing the correction values for the current DMB terminal in a correction value table;
reading a correction value corresponding to the current DMB channel and a current volume level set for the DMB terminal; and
correcting the default volume level of the DMB signal received on the current DMB channel using the correction value.

4. The method of claim 3, further comprising the steps of:
if the current DMB channel has been received before, reading a correction value corresponding to the current DMB channel and the current volume level set for the DMB terminal; and
correcting the default volume level of the DMB signal received on the current DMB channel using the correction value.

5. The method of claim 3, further comprising the steps of:
if the current volume level set in the DMB terminal is changed, reading a correction value corresponding to the current DMB channel and the changed volume level; and
correcting the default volume level of the DMB signal received on the current DMB channel using the correction value.

6. An apparatus for outputting an audio signal according to a digital multimedia broadcasting (DMB) channel in a DMB terminal, comprising:
a memory for storing a plurality of volume levels available to the DMB terminal; and
a DMB processor for comparing a default volume level of a DMB signal received on each of a plurality of DMB channels with the plurality of predetermined volume levels, determining correction values according to the differences between the default volume level and the plurality of predetermined volume levels, storing the correction values for the each of the plurality of DMB channels, reading, upon receipt of a DMB signal, a correction value according to a DMB channel on which the DMB signal is received and a current volume level set for the DMB terminal, and correcting the default volume level of the DMB signal using the correction value.

7. The apparatus of claim 6, wherein the DMB processor sets a correction value for attenuating a default volume level, if the default volume level is less than a preset volume level and sets a correction value for amplifying the default volume level, if the default volume level is greater than the preset volume level.
